(19) United States
(12) Patent Application Publication
(10) Pub. No.: US 2009/0195693 A1
(43) Pub. Date: Aug. 6, 2009

(54) COMPOSITE TUNER CAPABLE OF PREVENTING MUTUAL INTERFERENCE BETWEEN TERRESTRIAL BROADCAST AND SATELLITE BROADCAST

(76) Inventor: Atsumi YOKOYAMA, Osaka-shi (JP)

Correspondence Address: BIRCH STEWART KOLASCH & BIRCH, PO BOX 747, FALLS CHURCH, VA, 22040-0747, US

(21) Appl. No.: 12/364,983

(22) Filed: Feb. 3, 2009

(30) Foreign Application Priority Data
Feb. 4, 2008 (JP) 2008-023942

(51) Int. Cl. H04N 3/27; H04N 5/50

(52) U.S. Cl. 348/554; 348/731; 348/E03.049; 348/E05.097; 348/E05.108; 348/E05.114

(57) ABSTRACT

A satellite and terrestrial composite tuner includes a terrestrial broadcast tuner unit, a terrestrial broadcast demodulation unit, a satellite broadcast tuner unit, and a satellite broadcast demodulation unit. Since the satellite broadcast demodulation unit attains a power-saving mode to take an inactive state when a satellite broadcast is not received, power consumption is reduced. Further, when the satellite broadcast demodulation unit is in an inactive state, a total gain control unit suppresses increase in the total gain of the satellite broadcast tuner unit. As a result, radiation towards the terrestrial broadcast tuner unit caused by an I signal and Q signal amplified by AGC amplifiers can be suppressed.

This nonprovisional application is based on Japanese Patent Application No. 2008-023942 filed on Feb. 4, 2008, with the Japan Patent Office, the entire contents of which are hereby incorporated by reference.

### BACKGROUND OF THE INVENTION

1. Field of the Invention

The present invention relates to satellite and terrestrial composite tuners employed in receivers that can receive both a terrestrial broadcast and a satellite broadcast.

2. Description of the Background Art

For receivers that can receive a plurality of broadcast signals having a different frequency band, the event of one broadcast signal interfering with the other broadcast signal to degrade the signal quality must be prevented.

For example, Japanese Patent Laying-Open No. 2003-110444 discloses the technique of preventing the interference of a terrestrial system interfering with the reception of a transmission wave of a satellite system when both the satellite system and the terrestrial system receive signals at the same time.

According to this prior art, a control unit of a broadcast reception device monitors the signal level at a satellite RF (Radio Frequency) unit and a terrestrial RF unit as well as the error rate at a digital processor directed to demodulation. The control unit causes control such that a reception operation with respect to a transmission wave of the terrestrial system is stopped for a predetermined period when determination is made that the signal level of the transmission wave of the terrestrial system is high and the signal quality degraded, and also the signal level of the transmission wave of the satellite system is low and the signal quality degraded.

Accordingly, the event of the presence of a system with a high signal level and poor signal quality causing a disturbance to degrade the signal quality in a system that formerly should have favorable signal quality despite its low signal level, among a plurality of wireless systems, can be prevented.

Further, Japanese Patent Laying-Open No. 2003-283940 discloses a BS (Broadcast Satellite) digital tuner that can alleviate inter-modulation distortion caused by the interference wave of a CS (Communication Satellite) signal. According to this prior art, the switch of an IF (Intermediate Frequency) amplifier is switched, when BS digital broadcast signals are to be received, to raise the output of the BS digital tuner in the case where the CS signal level is significantly higher than the BS signal level.

At an AGC (Automatic Gain Control) circuit, a variable attenuator is controlled such that the level of the BS signal is reduced to a lower level. The transmitting signal is provided to the next RF amplifier and mixer circuit with its level narrowed. Accordingly, the level of the input signal towards the RF amplifier and mixer circuit is reduced to alleviate distortion in the reception signal occurring at these circuits to become the cause of an interfering wave.

To realize the capability of multi-channel recording and recording of a counter program on a different channel in accordance with the recent penetration of digital broadcasting, many of the apparatuses directed to broadcast reception such as a TV (television) incorporate a terrestrial broadcast tuner and a satellite broadcast tuner to allow simultaneous reception of a terrestrial broadcast and a satellite broadcast.

Conventionally, such reception apparatuses have separate tuner modules mounted respectively for a satellite broadcast and a terrestrial broadcast. In accordance with the general widespread use of the aforementioned features, a composite tuner having a satellite broadcast tuner circuit and a terrestrial broadcast tuner circuit integrated into one module has been developed and put on the market.

### SUMMARY OF THE INVENTION

The present invention is directed to a satellite and terrestrial composite tuner. An object of the present invention is to provide a satellite and terrestrial composite tuner of low power consumption without degradation in the reception performance.

The present invention is directed to a composite tuner employed in a broadcast receiver that can receive a terrestrial broadcast and a satellite broadcast. The composite tuner includes a terrestrial broadcast tuner unit, a terrestrial broadcast demodulation unit, a satellite broadcast tuner unit, a satellite broadcast demodulation unit, and a total gain control unit. The terrestrial broadcast tuner unit frequency-converts a terrestrial broadcast signal to a first signal having a frequency band lower than that of the terrestrial broadcast signal. The terrestrial broadcast demodulation unit receives and demodulates the first signal from the terrestrial broadcast tuner unit. The satellite broadcast tuner unit frequency-converts a satellite broadcast signal to a second signal having a frequency band lower than that of the satellite broadcast signal. The satellite broadcast demodulation unit attains an active state when the broadcast receiver receives a satellite broadcast to receive and demodulate the second signal from the satellite broadcast tuner unit, and attains an inactive state when the broadcast receiver is not receiving a satellite broadcast. The total gain control unit causes control such that, when the satellite broadcast demodulation unit is in an inactive state, the total gain of the satellite broadcast tuner unit is not increased as compared to that in an active state.

According to an aspect of the present invention, the satellite broadcast tuner unit adjusts the output level of the second signal according to an automatic gain control signal. The satellite broadcast demodulation unit outputs the automatic gain control signal according to the reception level of the second signal when in an active state. The total gain control unit sets the automatic gain control signal at a predetermined level when the satellite broadcast demodulation unit is in an inactive state.

Preferably, the total gain control unit includes a first terminal to supply a voltage of a predetermined level as an automatic gain control signal from a source external to the composite tuner when the satellite broadcast demodulation unit is in an inactive state.

Alternatively, the total gain control unit preferably includes a first power supply providing a voltage of a predetermined level, and a first switch circuit provided between an output node of the first power supply and a signal line through which the automatic gain control signal is transmitted. The satellite broadcast tuner unit further includes a tuner control unit that causes the first switch circuit to attain an OFF state and an ON state when the satellite broadcast demodulation unit is in an active state and an inactive state, respectively.

According to another aspect of the present invention, the satellite broadcast tuner unit includes a high frequency amplifier amplifying a satellite broadcast signal. The total gain control unit cuts off a power supply voltage of the high frequency amplifier when the satellite broadcast demodulation unit is in an inactive state.

Preferably, the total gain control unit includes a second terminal to supply the power supply voltage to the high frequency amplifier of the satellite broadcast tuner unit when the satellite broadcast demodulation unit is in an active state, and to stop supply of the power supply voltage when the satellite broadcast demodulation unit is in an active state.

Alternatively, the total gain control unit preferably includes a second switch circuit cutting off the power supply voltage of the high frequency amplifier, and a third terminal to supply a signal to set the second switch circuit to an OFF state when the satellite broadcast demodulation unit is in an inactive state.

Alternatively, the total gain control unit preferably includes a second switch circuit cutting off the power supply voltage of the high frequency amplifier. The satellite broadcast tuner unit further includes a tuner control unit setting the second switch circuit to an OFF state when the satellite broadcast demodulation unit is in an inactive state.

According to a further aspect of the present invention, a composite tuner employed in a broadcast receiver that can receive a terrestrial broadcast and a satellite broadcast includes a terrestrial broadcast tuner unit, a terrestrial broadcast demodulation unit, a satellite broadcast tuner unit, and a satellite broadcast demodulation unit. The terrestrial broadcast tuner unit frequency-converts a terrestrial broadcast signal to a first signal having a frequency band lower than that of the terrestrial broadcast signal. The terrestrial broadcast demodulation unit receives and demodulates the first signal from the terrestrial broadcast tuner unit. The satellite broadcast tuner unit frequency-converts a satellite broadcast signal to a second signal having a frequency band lower than that of the satellite broadcast signal. The satellite broadcast tuner unit includes a detection circuit detecting an output level of the second signal, and an automatic gain control circuit adjusting the output level of the second signal according to the detected value of the detection circuit. The satellite broadcast demodulation unit attains an active state when the broadcast receiver receives a satellite broadcast to demodulate the second signal, and attains an inactive state when the broadcast receiver is not receiving a satellite broadcast.

A first main advantage of the present invention is to allow reduction in power consumption since the satellite broadcast demodulation unit is in an inactive state when the broadcast receiver does not receive a satellite broadcast. Furthermore the total gain of the satellite broadcast tuner unit is suppressed by the total gain control unit when the satellite broadcast demodulation unit is in an inactive state in the present invention. Therefore, a second main advantage of the present invention is to prevent radiation of an interference wave to the terrestrial broadcast tuner unit to obtain favorable reception property since the output level of the second signal output from the satellite broadcast tuner unit is suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing a basic configuration of a satellite and terrestrial composite tuner 1 of the present invention.

FIG. 2 is a block diagram representing a configuration of a satellite and terrestrial composite tuner 1A according to a first embodiment of the present invention.

FIG. 3 is a block diagram representing a configuration of a satellite and terrestrial composite tuner 1B according to a second embodiment of the present invention.

FIG. 4 is a block diagram representing a configuration of a satellite and terrestrial composite tuner 1C according to a third embodiment of the present invention.

FIG. 5 is a block diagram representing a configuration of a satellite and terrestrial composite tuner 1D according to a fourth embodiment of the present invention.

FIG. 6 is a block diagram representing a configuration of a satellite and terrestrial composite tuner 1E according to a fifth embodiment of the present invention.

FIG. 7 is a block diagram representing a configuration of a satellite and terrestrial composite tuner 1F according to a sixth embodiment of the present invention.

### DESCRIPTION OF THE PREFERRED EMBODIMENTS

Embodiments of the present invention will be described in detail hereinafter with reference to the drawings. In the drawings, the same or corresponding elements have the same reference characters allotted, and description thereof will not be repeated.

### First Embodiment

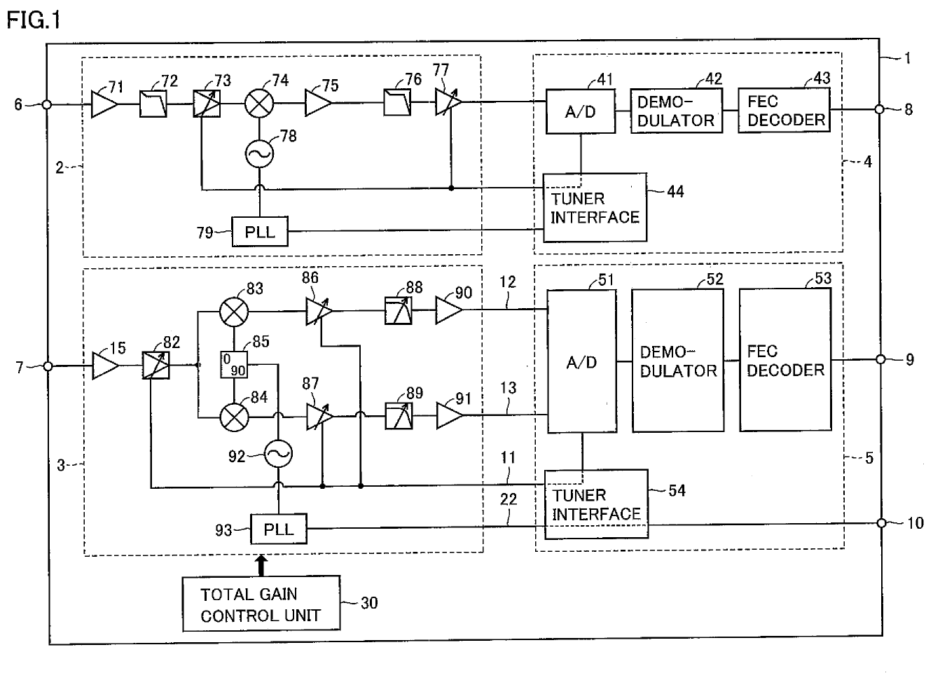

Referring to the block diagram of FIG. 1 representing a basic configuration, a satellite and terrestrial composite tuner 1 mainly includes a terrestrial broadcast tuner unit 2, a satellite broadcast tuner unit 3, a terrestrial broadcast demodulation unit 4, and a satellite broadcast demodulation unit 5.

Satellite and terrestrial composite tuner 1 further includes a terminal 6 to which a terrestrial broadcast signal is input, a terminal 7 to which a satellite broadcast signal is input, a terminal 8 from which a transport stream signal of a terrestrial broadcast is output, a terminal 9 from which a transport stream signal of a satellite broadcast is output, and an 12C terminal 10. 12C terminal 10 is connected to a microcontroller provided at a broadcast receiver in which satellite and terrestrial composite tuner 1 is incorporated. Satellite and terrestrial composite tuner 1 is under control of the microcontroller.

The configuration of each of units 2-4 of satellite and terrestrial composite tuner 1 will be described hereinafter, Terrestrial broadcast tuner unit 2 includes a high frequency amplifier 71, a filter 72, an AGC amplifier 73 for RF, a mixer 74, an IF amplifier 75, a filter 76, an AGC amplifier 77 for IF, an oscillator 78, and a tuner control unit 79.

A terrestrial broadcast signal input through terminal 6 of satellite and terrestrial composite tuner 1 is amplified at high frequency amplifier 71 and passes through filter 72. Then, the terrestrial broadcast signal has its level adjusted at AGC amplifier 73 to be provided to mixer 74. A signal from oscillator 78 is also input to mixer 74. The oscillation frequency of oscillator 78 is under control of a PLL (Phase-Locked Loop) circuit provided in tuner control unit 79. The terrestrial broadcast signal is multiplied by the signal of oscillator 78 at mixer 74 to be frequency-converted into an IF (Intermediate Frequency) signal.

The IF signal output from mixer 74 is amplified at IF amplifier 75, and passes through filter 76. Then, the IF signal has its level adjusted at AGC amplifier 77 to be output to terrestrial broadcast demodulation unit 4. AGC amplifiers 73 and 77 have the gain adjusted according to the AGC voltage (AGC signal) from terrestrial broadcast demodulation unit 4 such that the IF signal output to terrestrial broadcast demodulation unit 4 maintains an appropriate signal level. In FIG. 1, AGC amplifiers 73 and 77 are employed as an example of the AGC circuit.

Terrestrial broadcast demodulation unit 4 includes an A/D converter 41, a demodulator 42, an FEC (Forward Error Correction) decoder 43, and an interface circuit 44. An IF signal input to terrestrial broadcast demodulation unit 4 is converted into a digital signal by A/D converter 41, and then demodulated by demodulator 42. The demodulated signal is corrected for an error generated on the transmission path by FEC decoder 43 to be output as a transport stream signal from terminal 8.

Interface circuit 44 functions as an interface to output from terrestrial broadcast demodulation unit 4 a signal directed to controlling terrestrial broadcast tuner unit 2. For example, an AGC voltage is generated according to an IF signal detected at A/D converter 41 to be output to AGC amplifiers 73 and 77 via interface circuit 44.

Satellite broadcast tuner unit 3 includes a high frequency amplifier 15, an AGC amplifier 82 for high frequency, mixers 83 and 84, a 90-degree phase shifter 85, AGC amplifiers 86 and 87 for a baseband, low-pass filters 88 and 89, amplifiers 90 and 91, an oscillator 92, and a tuner control unit 93.

Satellite broadcast tuner unit 3 shown in FIG. 1 is employed for a satellite broadcast signal that is digital-modulated in a QPSK (Quadrature Phase Shift Keying) scheme, for example. The satellite broadcast signal is received at an antenna (not shown), frequency-converted to a signal of an intermediate frequency band at a converter (not shown) provided in the antenna, and then directed to satellite broadcast tuner unit 3.

The satellite broadcast signal applied to satellite broadcast tuner unit 3 is amplified at high frequency amplifier 15 located at the input stage, and then has its level adjusted at AGC amplifier 82. The level-adjusted satellite broadcast signal is applied to mixers 83 and 84. A signal from oscillator 92 is converted at 90-degree phase shifter 85 into two signals having a phase difference of 90 degrees. These two signals are applied to mixers 83 and 84. The oscillation frequency of oscillator 92 is under control of a PLL (Phase-Locked Loop) circuit provided at tuner control unit 93. The satellite broadcast signal is multiplied by the signals from 90-degree phase shifter 85 at mixers 83 and 84, respectively, to be output as an I signal and a Q signal that are baseband signals.

The output I signal has its level adjusted at AGC amplifier 86, and passes through filter 88. The I signal applied through filter 88 is amplified by amplifier 90, and then provided to satellite broadcast demodulation unit 5 via an I signal line 12. The Q signal has its level adjusted at AGC amplifier 87, and then passes through filter 89. The Q signal applied through filter 89 is amplified at amplifier 91 to be output to satellite broadcast demodulation unit 5 via a Q signal line 13.

AGC amplifiers 82, 86 and 87 have the gain adjusted according to the AGC voltage (AGC signal) from satellite broadcast demodulation unit 5 such that the I signal and Q signal provided to satellite broadcast demodulation unit 5 maintain an appropriate signal level. In FIG. 1, AGC amplifiers 82, 86 and 87 are employed as an example of the AGC circuit. Filters 88 and 89 are low-pass filters, whose passband is modified according to the signal band of the I and Q signals.

Satellite broadcast demodulation unit 5 includes an A/D converter 51, a demodulator 52, an FEC decoder 53, and an interface circuit 54. The I signal and Q signal output from satellite broadcast tuner unit 3 are converted into digital signals by A/D converter 51, and then demodulated by demodulator 52. The demodulated signals are corrected for an error generated on the transmission line by FEC decoder 53, and then output from terminal 9 as transport stream signals.

Interface circuit 54 functions as an interface to output from satellite broadcast demodulation unit 5 a signal directed to controlling satellite broadcast tuner unit 3. An AGC voltage is generated according to the I and Q signals detected at A/D converter 51 to be supplied from interface circuit 54 to AGC amplifiers 82, 86 and 87 via an AGC signal line 11. The control signal applied from the microcontroller is supplied from interface circuit 54 to tuner control unit 93 of satellite broadcast tuner unit 3 via a control signal line 22. The control signal from the microcontroller includes information of the frequency data of the PLL circuit, the operation mode (normal mode, power-saving mode) of the receiver, and the like.

Satellite and terrestrial composite tuner I includes a normal mode and a power-saving mode as operation modes in order to reduce power consumption. In the case where only a terrestrial broadcast is being watched or recorded, the apparatus operates in a power-saving mode in which satellite broadcast demodulation unit 5 is set in an inactive state since a satellite broadcast does not have to be received. It is to be noted that, even when a satellite broadcast is not received, satellite broadcast tuner unit 3 does not take an inactive state and maintains a channel-selecting state so as to immediately respond to the case where a request to watch a satellite broadcast suddenly occurs. Satellite broadcast demodulation unit 5 takes a general active state when a satellite broadcast is being received.

When the satellite broadcast demodulation unit is in an inactive state, poor reception may occur in the terrestrial broadcast. As a result of study, it is considered that the phenomenon is caused by the mechanism set forth below.

When satellite broadcast demodulation unit 5 is in an inactive state by the power-saving mode, the AGC voltage attains the level of zero since power supply to interface circuit 54 is also stopped. The gain of AGC amplifiers 82, 86 and 87 of satellite broadcast tuner unit 3 becomes larger as the AGC voltage becomes smaller. Therefore, the total gain of satellite broadcast tuner unit 3 will attain the highest level when the AGC voltage is zero. As a result, the I signal and Q signal will become extremely high in intensity. Such high I and Q signals cause radiation, applied to terrestrial broadcast tuner unit 2 as an interference signal. Thus, the purity of the signal in a terrestrial broadcast is degraded to cause poor reception.

To prevent such poor reception, satellite and terrestrial composite tuner 1 further includes a total gain control unit 30 causing control such that the total gain of satellite broadcast tuner unit 3 does not increase when satellite broadcast demodulation unit 5 is in an inactive state. As a result, the I signal and Q signal output from satellite broadcast tuner unit 3 are suppressed, and radiation of an interference wave towards terrestrial broadcast tuner unit 2 is prevented. Thus, a favorable reception property can be achieved.

As an overview, satellite and terrestrial composite tuner 1 can receive a terrestrial broadcast and a satellite broadcast at the same time by including terrestrial broadcast tuner unit 2, terrestrial broadcast demodulation unit 4, satellite broadcast tuner unit 3, and satellite broadcast demodulation unit 5. Further, reduction in power consumption in the case where a satellite broadcast is not received is allowed by including a satellite broadcast demodulation unit 5 that has a power-saving mode. Moreover, increase in the total gain of satellite broadcast tuner unit 3 is suppressed by total gain control unit 30 when a satellite broadcast is not received. As a result, the I signal and Q signal output from satellite broadcast tuner unit 3 are suppressed, and radiation of an interference wave towards terrestrial broadcast tuner unit 2 is prevented. Thus, a favorable reception property can be achieved.

Total gain control unit 30 will be described in detail hereinafter.

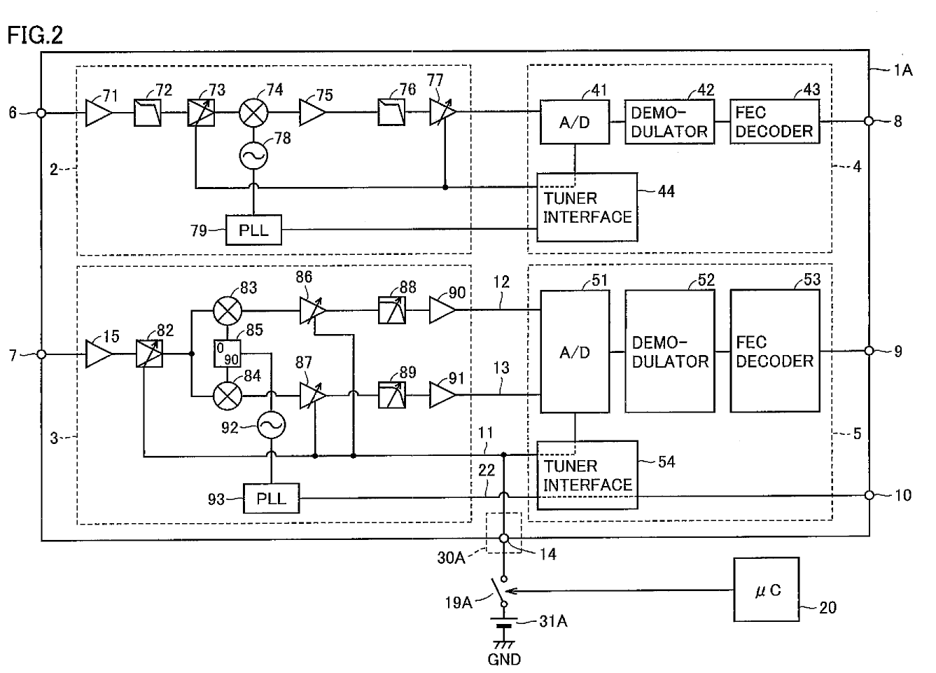

FIG. 2 is a block diagram representing a configuration of a satellite and terrestrial composite tuner 1A of the first embodiment, including a specific example of a configuration of total gain control unit 30 shown in FIG. 1.

Referring to FIG. 2, a total gain control unit 30A includes an external AGC terminal 14 to control AGC voltage from a source external to satellite and terrestrial composite tuner 1. External AGC terminal 14 is connected to AGC signal line 11.

To external AGC terminal 14 is connected a switch circuit 19A that can apply and cut off a voltage 31A to and from external AGC terminal 14. Switch circuit 19A has its ON or OFF state switched under control of a microcontroller 20 that causes control of the entire broadcast receiver.

When a satellite broadcast is received, microcontroller 20 cuts off switch circuit 19A. The AGC voltage fed back by satellite broadcast demodulation unit 5 is applied to AGC amplifiers 82, 86 and 87.

When a satellite broadcast is not received, microcontroller 20 sets satellite broadcast demodulation unit 5 in a power-saving mode, and connects switch circuit 19A. As a result, an AGC voltage is supplied from a source external to satellite and terrestrial composite tuner 1A. The externally applied voltage 31A is set in advance at a sufficient high level such that the total gain of satellite broadcast tuner unit 3 is small enough, i.e. such that the radiation of the I signal and Q signal does not disturb the reception of the terrestrial broadcast tuner unit.

According to total gain control unit 30A of the first embodiment, the AGC voltage is set such that the total gain of satellite broadcast tuner unit 3 is small enough when the satellite broadcast demodulation unit is in an inactive state according to a power-saving mode. Thus, the radiation of I and Q signals can be readily suppressed.

Further, the AGC voltage applied via external AGC terminal 14 from a source external to satellite and terrestrial composite tuner 1 is under control of microcontroller 20. Therefore, the AGC voltage can be controlled readily and immediately.

### Second Embodiment

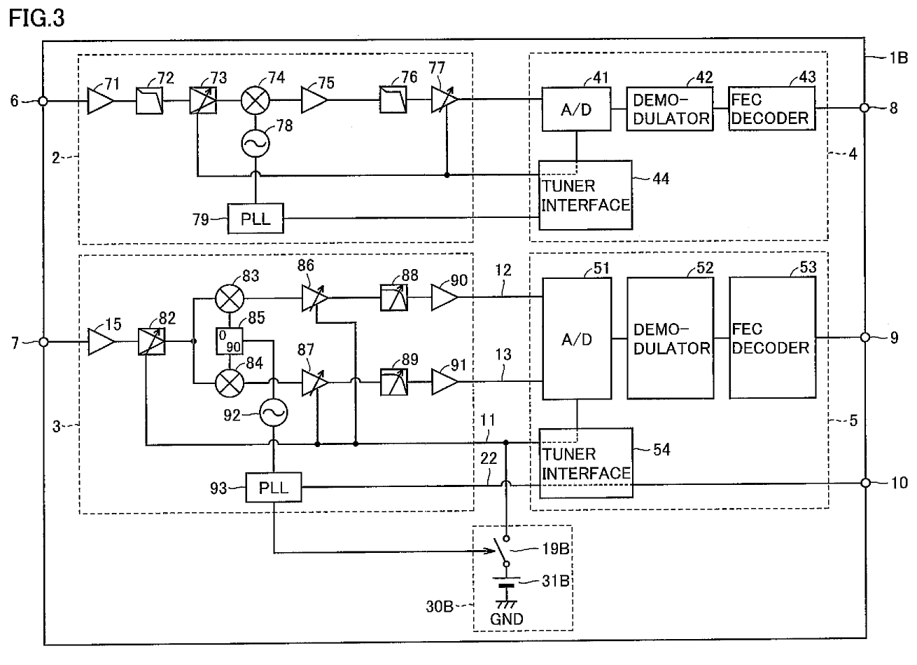

FIG. 3 is a block diagram representing a configuration of a satellite and terrestrial composite tuner 1B according to a second embodiment of the present invention, including a specific example of total gain control unit 30 shown in FIG. 1.

Referring to FIG. 3, a total gain control unit 30B includes a direct current power supply 31B, and a switch circuit 19B connected between AGC signal line 11 and the output node of direct current power supply 31B. The power supply voltage is applied to and cut off from AGC signal line 11 by switch circuit 19B. Switch circuit 19B is turned to an ON state or OFF state according to a control signal applied from tuner control unit 93 of satellite broadcast tuner unit 3. Information such as the operation mode of satellite broadcast demodulation unit 5 is applied to tuner control unit 93 from microcontroller 20 via I2C terminal 10. Thus, the second embodiment differs from the first embodiment in that direct current power supply 31B and switch circuit 19B are incorporated in satellite and terrestrial composite tuner 1B.

When a satellite broadcast is currently received, tuner control unit 93 cuts off switch circuit 19B. The AGC voltage is feedback-controlled by satellite broadcast demodulation unit 5. When satellite broadcast demodulation unit 5 is in a power-saving mode when a satellite broadcast is not received, tuner control unit 93 connects switch circuit 19B The AGC voltage is fixed at power supply voltage 31B. As described in association with the first embodiment, the level of power supply voltage 31B is determined in advance at a sufficiently high level such that the total gain of satellite broadcast tuner unit 3 is small enough.

According to total gain control unit 30B of the second embodiment, the AGC voltage is under control of tuner control unit 93 of satellite broadcast tuner unit 3. Accordingly, satellite and terrestrial composite tuner 1B having a favorable reception property can be implemented more economically and readily as compared to the first embodiment.

### Third Embodiment

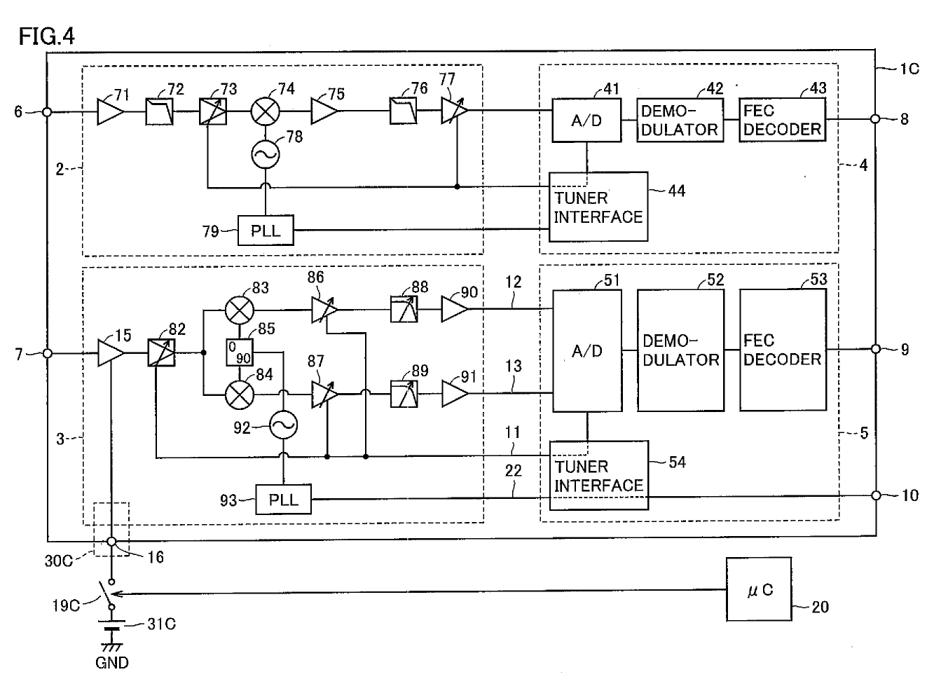

FIG. 4 is a circuit diagram representing a configuration of a satellite and terrestrial composite tuner 1C according to a third embodiment of the present invention, including a specific example of a configuration of total gain control unit 30 shown in FIG. 1.

Referring to FIG. 4, a total gain control unit 30C includes a dedicated power supply terminal 16 to supply power supply voltage 31C towards high frequency amplifier 15 of satellite broadcast tuner unit 3. To power supply terminal 16 is connected a switch circuit 19C to supply and cut supply of power supply voltage 31C. Switch circuit 19C has its ON state or OFF state switched under control of microcontroller 20 that causes control of the entire broadcast receiver.

When a satellite broadcast is to be received, microcontroller 20 sets switch circuit 19C at an ON state. Power supply voltage 31C is supplied to high frequency amplifier 15. When a satellite broadcast is not received, microcontroller 20 cuts off switch circuit 19C. Supply of power supply voltage 31C to high frequency amplifier 15 is stopped. Accordingly, the total gain of satellite broadcast tuner unit 3 is greatly reduced since high frequency amplifier 15 no longer operates.

According to total gain control unit 30C of the third embodiment, the total gain of satellite broadcast tuner unit 3 can be reduced readily by cutting the connection between high frequency amplifier 15 of satellite broadcast tuner unit 3 and power supply 31C. Further, satellite and terrestrial composite tuner 1C of the third embodiment has the power supply voltage of high frequency amplifier 15 cut off when in a power-saving mode. Therefore, power consumption of the satellite and terrestrial composite tuner can be further reduced as compared to the case of the first and second embodiments.

Further, since a switch circuit 19C that supplies or cuts the power supply voltage to high frequency amplifier 15 is provided outside of satellite and terrestrial composite tuner 1, control of the power supply voltage of high frequency amplifier 15 can be carried out economically.

### Fourth Embodiment

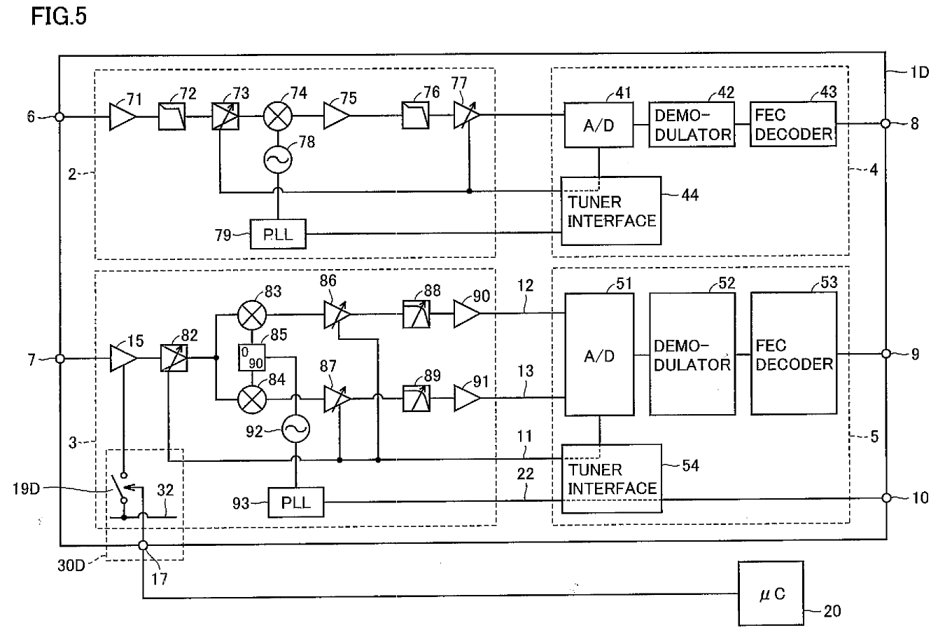

FIG. 5 is a block diagram representing a configuration of a satellite and terrestrial composite tuner 1D according to a fourth embodiment of the present invention, including a specific example of a configuration of total gain control unit 30 shown in FIG. 1.

Referring to FIG. 5, a total gain control unit 30D includes a switch circuit 19D connected between a power supply line 32 and high frequency amplifier 15 in satellite broadcast tuner unit 3, and a control terminal 17 to carry out control of a switch circuit 19D. A control signal to control the switching of switch circuit 19D to an ON state or OFF state is provided from microcontroller 20 via control terminal 17.

Likewise with the third embodiment, microcontroller 20 connects switch circuit 19D when a satellite broadcast is received. As a result, a voltage is supplied from power supply line 32 towards high frequency amplifier 15. When a satellite broadcast is not received, voltage supply to high frequency amplifier 15 is stopped since switch circuit 19D is cut off. Accordingly, the total gain of satellite broadcast tuner unit 3 is greatly reduced since high frequency amplifier 15 no longer operates.

According to total gain control unit 30D of the fourth embodiment, the total gain of satellite broadcast tuner unit 3 can be reduced readily by cutting the connection between high frequency amplifier 15 and power supply line 32 of satellite broadcast tuner unit 3. Therefore, power consumption of the satellite and terrestrial composite tuner can be further reduced as compared to the case of the first and second embodiments, likewise with the third embodiment.

In the fourth embodiment, a switch circuit 19D to supply or cut off the power supply voltage to high frequency amplifier 15 is incorporated in satellite and terrestrial composite tuner 1D. Therefore, designing a broadcast receiver in which satellite and terrestrial composite tuner 1D is incorporated is facilitated.

### Fifth Embodiment

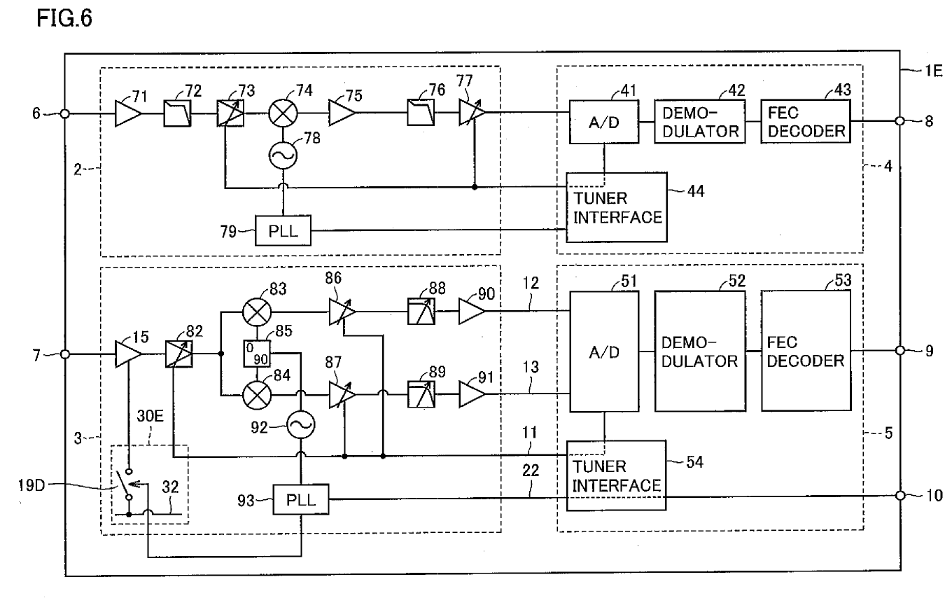

FIG. 6 is a circuit diagram representing a configuration of a satellite and terrestrial composite tuner 1E according to a fifth embodiment of the present invention, including a specific example of a configuration of total gain control unit 30 shown in FIG. 1.

Referring to FIG. 6, a total gain control unit 30E includes switch circuit 19D connected between internal power supply line 32 and high frequency amplifier 15 in satellite broadcast tuner unit 3. Switch circuit 19D is switched to an ON state or OFF state according to a control signal applied from tuner control unit 93 of satellite broadcast tuner unit 3. Information such as the operation mode of satellite broadcast demodulation unit 5 is applied to tuner control unit 93 from microcontroller 20 via 12C terminal 10.

When a satellite broadcast is received, tuner control unit 93 sets switch circuit 19D at an ON state. Power supply voltage is supplied towards high frequency amplifier 15 from power supply line 32. When a satellite broadcast is not received, tuner control unit 93 cuts off switch circuit 19D when satellite broadcast demodulation unit 5 is in a power-saving mode. Thus, supply of power supply voltage to high frequency amplifier 15 is stopped.

According to total gain control unit 30E of the fifth embodiment, the total gain of satellite broadcast tuner unit 3 can be readily reduced by cutting the connection between high frequency amplifier 15 and power supply line 32 of satellite broadcast tuner unit 3. Further, likewise with the third embodiment, the power consumption of the satellite and terrestrial composite tuner can be further reduced than in the first and second embodiments, likewise with the third embodiment.

Further, the fifth embodiment is based on a configuration in which control of supplying or cutting the power supply voltage with respect to high frequency amplifier 15 is carried out according to a control signal output from tuner control unit 93 of satellite broadcast tuner unit 3. Accordingly, a satellite and terrestrial composite tuner 1E can be implemented more economically and readily as compared to the third and fourth embodiments.

### Sixth Embodiment

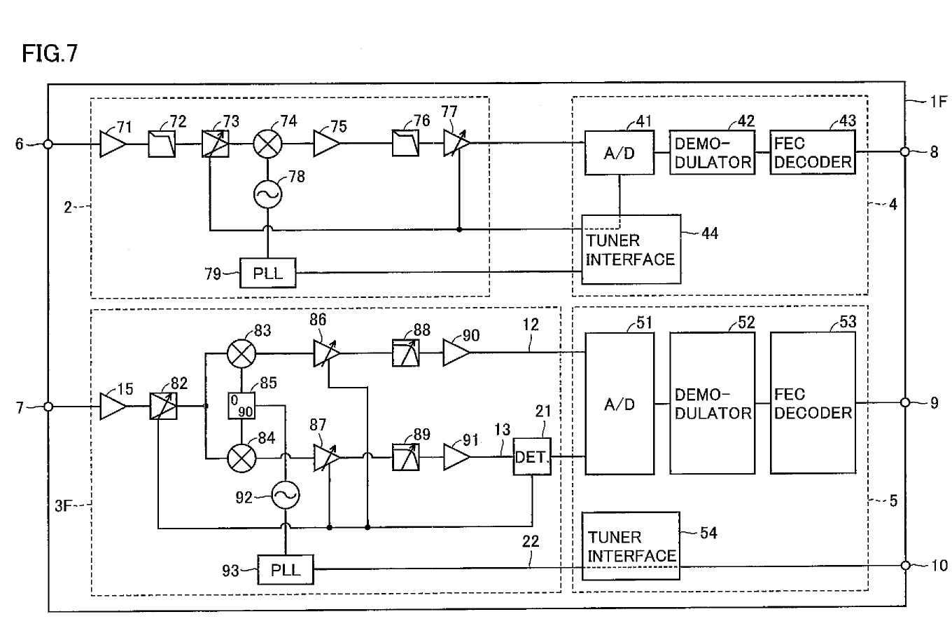

FIG. 7 is a block diagram representing a configuration of a satellite and terrestrial composite tuner 1F according to a sixth embodiment of the present invention, corresponding to a modification of satellite and terrestrial composite tuner 1 of FIG. 1.

Referring to FIG. 7, a satellite broadcast tuner unit 3F of satellite and terrestrial composite tuner 1F differs from satellite broadcast tuner unit 3 of FIG. 1 in that a detection circuit 21 is connected to Q signal line 13. Detection circuit 21 may be connected to I signal line 12. Detection circuit 21 detects the output level of an I signal or Q signal.

Further, satellite broadcast tuner unit 3F of the sixth embodiment differs from satellite broadcast tuner unit 3 of FIG. 1 in that the AGC voltage to control AGC amplifiers 82, 86 and 87 of satellite broadcast tuner unit 3F is feedback-controlled by an output from detection circuit 21, instead of the output of A/D converter 51. Therefore, the AGC voltage is feedback-controlled in the sixth embodiment such that the intensity of an I signal or Q signal detected by detection circuit 21 attains a constant level.

It is to be noted that a total gain control unit 30 set forth in the first to fifth embodiments is not provided in the sixth embodiment. With regards to the remaining elements, satellite and terrestrial composite tuner 1F of FIG. 7 is similar to satellite and terrestrial composite tuner 1 of FIG. 1. Therefore, common elements will not be described repeatedly.

Satellite and terrestrial composite tuner 1F of the sixth embodiment is based on a configuration in which satellite broadcast tuner unit 3 itself conducts the feedback-control of AGC amplifiers 82, 86 and 87. Therefore, the I signal or Q signal will not be increased even when satellite broadcast demodulation unit 5 attains an inactive state by the power-saving mode. Therefore, poor reception in a terrestrial broadcast will not occur. Further, control through switch circuits 19A, 19B, 19C and 19D, as in the first to fifth embodiments, is not required.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A composite tuner employed in a broadcast receiver that can receive a terrestrial broadcast and a satellite broadcast, comprising:
a terrestrial broadcast tuner unit frequency-converting a terrestrial broadcast signal to a first signal having a frequency band lower than the frequency band of said terrestrial broadcast signal,
a terrestrial broadcast demodulation unit receiving and demodulating said first signal from said terrestrial broadcast tuner unit,
a satellite broadcast tuner unit frequency-converting a satellite broadcast signal to a second signal having a frequency band lower than the frequency band of said satellite broadcast signal,
a satellite broadcast demodulation unit attaining an active state when said broadcast receiver is receiving said satellite broadcast to receive and demodulate said second signal from said satellite broadcast tuner unit, and attaining an inactive state when said broadcast receiver is not receiving said satellite broadcast, and
a total gain control unit causing control such that a total gain of said satellite broadcast tuner unit is not increased as compared to the total gain in said active state when said satellite broadcast demodulation unit is in said inactive state.

2. The composite tuner according to claim 1, wherein
said satellite broadcast tuner unit adjusts an output level of said second signal according to an automatic gain control signal,
said satellite broadcast demodulation unit outputs said automatic gain control signal according to a reception level of said second signal when in said active state, and
said total gain control unit sets said automatic gain control signal at a predetermined level when said satellite broadcast demodulation unit is in said inactive state.

3. The composite tuner according to claim 2, wherein said total gain control unit includes a first terminal to supply a voltage of a predetermined level as said automatic gain control signal from a source external to said composite tuner when said satellite broadcast demodulation unit is in inactive state.

4. The composite tuner according to claim 2, wherein
said total gain control unit includes
a first power supply providing a voltage of a predetermined level, and
a first switch provided between an output node of said first power supply and a signal line through which said automatic gain control signal is transmitted,
said satellite broadcast tuner unit further includes a tuner control unit causing said first switch circuit to attain an OFF state and an ON state when said satellite broadcast demodulation unit is in said active state and said inactive state, respectively.

5. The composite tuner according to claim 1, wherein
said satellite broadcast tuner unit includes a high frequency amplifier amplifying said satellite broadcast signal,
said total gain control unit cuts off a power supply voltage of said high frequency amplifier when said satellite broadcast demodulation unit is in said in inactive state.

6. The composite tuner according to claim 5, wherein said total gain control unit includes a second terminal to supply the power supply voltage to said high frequency amplifier of said satellite broadcast tuner unit when said satellite broadcast demodulation unit is in said active state, and stops supply of the power supply voltage when said satellite broadcast demodulation unit is in said inactive state.

7. The composite tuner according to claim 5, wherein said total gain control unit includes
a second switch circuit cutting off the power supply voltage of said high frequency amplifier, and
a third terminal to supply a signal directed to setting said second switch circuit at an OFF state when said satellite broadcast demodulation unit is in said inactive state.

8. The composite tuner according to claim 5, wherein
said total gain control unit includes a second switch circuit cutting off the power supply voltage of said high frequency amplifier, and
said satellite broadcast tuner unit further includes a tuner control unit setting said second switch circuit at an OFF state when said satellite broadcast demodulation unit is in said inactive state.

9. A composite tuner employed in a broadcast receiver that can receive a terrestrial broadcast and a satellite broadcast, comprising:
a terrestrial broadcast tuner unit frequency-converting a terrestrial broadcast signal to a first signal having a frequency band lower than the frequency band of said terrestrial broadcast signal,
a terrestrial broadcast demodulation unit receiving and demodulating said first signal from said terrestrial broadcast tuner unit,
a satellite broadcast tuner unit frequency-converting a satellite broadcast signal to a second signal having a frequency band lower than the frequency band of said satellite broadcast signal, said satellite broadcast tuner unit including
a detection circuit detecting an output level of said second signal, and
an automatic gain control circuit adjusting an output level of said second signal according to a detected value of said detection circuit, and
a satellite broadcast demodulation unit attaining an active state when said broadcast receiver is receiving said satellite broadcast to demodulate said second signal, and attaining an inactive state when said broadcast receiver is not receiving said satellite broadcast.
